(19) United States
(12) Patent Application Publication
(10) Pub. No.: US 2016/0318205 A1
(43) Pub. Date: Nov. 3, 2016

(54) METHOD FOR MACHINING WOODEN ARTICLES ACROSS THE GRAIN IN TWO OR MORE PLANES WITH DIFFERENT TYPES OF TRANSVERSE SECTIONS

(71) Applicant: VLADIMIR VLADIMIROVICH OPARIN, Kirov (RU)

(72) Inventor: VLADIMIR VLADIMIROVICH OPARIN, Kirov (RU)

(21) Appl. No.: 14/442,099

(22) PCT Filed: Nov. 6, 2013
(86) PCT No.: PCT/RU2013/000982

§ 371 Date: Jul. 25, 2016

(30) Foreign Application Priority Data
Nov. 12, 2012 (RU) 2012148107

(51) Int. Cl. B27F 1/00; B27M 1/08

(52) U.S. Cl. CPC B27F 1/00; B27M 1/08

(57) ABSTRACT

This invention relates to the woodworking industry. The method of processing of wood products across the grain in two or more planes with various cross-section shapes includes orientation, locating with subsequent clamping, feeding and processing along the mutually perpendicular generatrices. Multiple products can be processed at the same time. The products are placed in the transverse direction relative to the longitudinal axis of the product, as well as to the longitudinal axis of the processing lines, and to the longitudinal axis of the bench. The products are shifted from the processing lines so that all the auxiliary operations are performed simultaneously and automatically in each plane. The lengths of the products to be processed simultaneously shall be matched with respect to each other to satisfy the condition under which their total length shall be equal or as close as possible to the length of the standard input workpiece. For processing, the products shall be moved with respect to the fixed electric power drives. Operations of each product processing are divided into groups of operations. Each group of operations processes simultaneously the products throughout the length of the workpiece in one plane. The time of executions of all the groups of operations shall be equal, or closely comparable to each other. Each group of operations is performed in a separate zone. After completing a group of operations, the products are moved to the next zone. The zone of the previous operations shall be freed for processing the next product. Starting from the number of a group of operations for processing the products in the first plane, corresponding to the quantity of groups of operations into which the full cycle of products processing is divided, the processing of the products is performed simultaneously in all the processing planes. The procedure of simultaneous processing of product batches in all planes shall be repeated until the full completion of the product batch processing. The processing of the next product batch is performed in the same way. This improves the product processing performance. 5 figures.

The invention relates to the woodworking industry, notably to the equipment for manufacturing elements of residential, social and industrial buildings, and it can be used in woodworking, construction and other industries.

Actually, there is the following trend in the wood processing equipment: in the design of multipurpose processing stations for processing wood across the grain in multiple planes, the vendors opt for implementation of consecutive execution of multiple single working operations as required for the full cycle of one workpiece processing, in the course of which there is a need for multiple discrete changes in the workpiece position relative to the bench and multiple repositioning of the workpiece required for subsequent process operation. This requires in addition multiple repeated auxiliary processing operations, both preceding and following the working operations in the course of every single processing operation such as moving, positioning, clamping and releasing the workpiece,etc. In case of sequential processing, running a single processing operation hinders the simultaneous execution of other process operations, and this principle is originally included in the design and technology of the equipment in use. Even when the process operations are fully automated using existing equipment for processing wood workpieces (beams, planks) across the grain, such equipment has significant drawbacks which result in large unproductive waste of time and, as a consequence, in an extremely low productivity, for instance, in case of the benches processing wood workpieces in the longitudinal direction (four-sider straightening planers).

There are known methods of processing beam workpieces across the grain using wood processing stations for Processing beam workpieces across the grain HUNDEGGER K2, SCHMIDLER 84 (Germany), EUROBLOX, TOPMASTER (Italy), BL Twin (Austria), Logmatic, KRUSI CM-40 (Finland), LSM-400AM (Lithuania), FORMAT-250, BKR-19, BLOKS-4, MChS-2B, WoodTec (Russia). Disadvantages of using the known devices are as follows: sequential execution of operations for processing in multiple planes delivers poor performance (each operation being executed on a separate device), and high cost of equipment. For instance, the HUNDEGGER K2 automatic line comprises 15 devices, ensuring the workpiece processing in three planes (http://www.intervespstanki.ru/item/hundegger_k-2.htm), is characterized by high cost, requires large production areas, which, in turn, increases the cost of the finished product.

There is a known technical solution under the patent RU 2212998 C1 B27C 5/00, published on Sep. 27, 2003, according to which wood-processing pattern cutting station includes a frame on which are located guiding ways and an electric motor for moving the table, connected to a screw, the nut of which is fixed on the table surface; a gantry, on the surface whereof are installed guiding ways of the support, whereon is installed an electric motor for moving the same and an electric motor of adjustable stops, coupled with a beam, of two milling electric spindles. Each of electric spindles features vertical guiding ways, a pneumatic cylinder and a program control system. The electric motors for moving the support and the stops are installed vertically on both sides of the support whereon are located two electric spindles; the gantry has a rack; the gearwheel of the latter is connected to the electric motor used for moving the support. The stops beam is installed on guiding ways between two electric spindles and has a nut of the screw-type ball gear, the screw of which is connected to the electric motor used for moving the stops. The table is equipped with a vacuum system for holding the workpieces. The disadvantage is sequential running the operations, which gives poor processing performance.

There is a known technical solution under the patent RU 2351461 C2B27C 9/00, published on Apr. 10, 2009, according to which the wood-processing bench includes a frame, supporting and turning arrangement; a carriage with work tools installed on guiding ways of the frame. supporting and turning arrangement comprises a foresupporting and turning arrangement—headstock on the spindle of which there is face plate with indexing holes, synchronized with a winch fixed on the frame and provided with a cable fastened to the carriage for moving the latter, and a rear supporting arrangement—tailstock; the headstock electric motor. The carriage installed on the guiding ways of the frame and provided with work tools comprises a foreuniversal crossarm whereon the process equipment is installed, including the milling cutter shaft, the axis of which is positioned at an angle of 13-15° to the axis of the log in the horizontal plane; a universal milling head, an electric motor, a band-saw disc, a restraint bracket of the band saw, a band saw, and the second moving rear crossarm, whereon guiding ways are installed upon which the mobile milling head moves which includes a universal milling cutter, a milling cutter shaft, a milling head with replaceable blades, the axis of which is positioned in the horizontal plane at an angle of 13-15° to the axis of moving of the mobile milling head, the electric motor, reduction gears installed on the carriage for moving the crossarms up and down, and a brake for smooth moving of the carriage along the guiding ways. The disadvantage is sequential execution of the operations, which gives poor processing performance.

There is a known method of processing beam workpieces using the end-trimming benchTs2T60 (http://www.ksz.kirov.ru/c2t60.htm), the manufacturer of which is KIROVSKY STANKOZAVOD, LLC (RUSSIA). The straight-type double-sidedend-trimming benchTs2T60 is intended for trimming the edged timber from two sides simultaneously; the design features: the frame is a welded frame structure and the end of which are installed two trimming saws; adjustment to the length of the timber is performed by moving the right saw installed on a mobile carriage; feeding the material into the cutting zone is performed by four special pushers installed on a chain: this ensures reducing the injury factor during the machine operation; the lower part of the saw is enclosed in a housing provided with holes to remove the saw dust. The upper (working) part of the saw is protected by a mobile guard which rises, turning on its axis under the action of the workpiece being fed, and lowers after the latter leaves the cutting zone. The disadvantages are as follows: this bench is not intended for processing workpieces in multiple planes, accordingly, in order to get the finished product, one needs at least one more machine, which, including the auxiliary operations, results in poor performance.

The most close to the claimed invention is the method of beams processing under the patent RU 2007291 C1 B27C 1/12, published on Feb. 15, 1994, according to which during the beams processing, the locating and orientation Operations are combined and performed along two mutually perpendicular generatrices. Without re-locating, the beams are processed in one pass. Then the remaining generatrices are subjected to profiling and finishing operations, which can also be performed concurrently. Locating is performed by means of two clamping elements, self-adjusting along one of the lateral generatrices. Herewith, each element is shifted to a different height, depending on the beam camber, until its touches the surface. A drawback of the pilot model is that it does not provides for making transverse slots in the beam, and for this purpose the workpiece shall be moved to the tenon cutting bench. The result is a poor performance while manufacturing new finished products from wooden beams.

The claimed invention allows for eliminating the said drawback and improving the productivity due the execution of all the operations as required for beams processing. The suggested method of processing wood workpieces across the grain eliminates the above reasons of poor performance incidental to existing equipment. This being the case, the performance rate of the equipment, based on the new technique of wood processing, increases multiple times and becomes comparable to that of the existing equipment for processing wood along the grain (planing machines), which makes it possible to create a unique technological chain, optimized in terms of productivity, when it is necessary to provide for the full cycle of wood workpieces processing along and across the grain in multiple planes.

The technical task is to improve the productivity of long-length workpieces processing through simultaneous processing in three planes. To solve this problem, a method is proposed which allows for implementing operations (except for end-trimming) for cutting slots of “wind lock” type for transverse connection of wooden pieces.

The suggested method of wood products processing across the grain minimizes the unproductive waste of time while using the existing benches, ensures performing of the maximum number of simultaneous working and auxiliary operations, provides for simultaneous processing of one or more products throughout the length of the latter during processing in one processing plane, makes it possible simultaneous processing of products in all the processing planes in case of batch treatment, notably:
when performing any group of operations, it realizes the possibility of simultaneous product processing throughout its length (as a special case, it is allowed to perform some group of operations successively, if the time of execution of the successive operations does not exceed the time of other operations);
it realizes simultaneous performing of all group of operations, i.e. batch processing is performed simultaneously in all groups (i.e. in all planes, as required for the full cycle of one workpiece processing), but each group of operations is performed with different products from the batch of products to be processed, being fed into the bench consecutively, one after another;
simultaneous performing of all group of operations is realized upon execution of the first group of operations for processing the product, the sequence of feeding whereof into the bench for processing coincides with the number of groups of operations into which the full cycle of one workpiece processing is divided;
when performing each group of operations, it realizes the possibility to reduce all working and auxiliary process Operations to one general simultaneous operation allowing to process the product completely and throughout all the length in the given plane;
when performing simultaneously all the operations of one group, whereas the time of performing one group of operations is reduced, throughout the length of the product being processed, to the time of performing one general simultaneous operation and becomes much less than the time of performing a single working operation combined with required auxiliary operations, that the existing benches may execute only consecutively or alternately;
when performing simultaneously the product processing in all planes is case of batch processing, the time of full processing of one product in all planes is divided into the number of groups of operations, is reduced the given number of times and becomes virtually equal to the time of performing one group of operations;
the productivity of such benches is not decreased when increasing the number of product processing operations which are as required for the full cycle of product processing, and the greater is the number of operations to be performed for the full cycle of one workpiece processing, the better is the performances of such benches as compared to those existing actually;
the performances of the benches based on the new method of wood workpiece processing across the grain in multiple planes, as compared to existing wood processing benches for fabrication of similar wooden products, should be increased 10 times and more, according to preliminary calculations.
the application of the claimed method of wood processing across the grain in three and more planes allows for creating a unique process chain, optimized in terms of performance parameters, as required for the full cycle of wood workpiece processing along and across the grain in all planes. The method is claimed, according to which the preliminary operations create a basis upon which the following multisided process is performed. Where possible, the cycles of multisided processing shall be performed in one pass. Thus, when creating the basis for the first operation along with its simultaneously processing, and further on, with orientation and locating the workpiece along the processed mutually perpendicular generatrices (locating the beams in two adjacent plates by two points), the required profiling processing is performed, and all this can be performed in one pass. Thus the processing performance is increased, which is the goal of the invention.

The technical result is increasing productivity when processing a wood product, a long-length wood workpiece, Notably when cutting “wind lock” type slots for transverse connection of wooden pieces.

This technical results is achieved due to the fact that the method for processing wood products across the grain in two or more planes with various cross-section shapes, including orientation, locating, with subsequent clamping, feeding and processing along the mutually perpendicular generatrices, is characterized in that multiple products can be processed at the same time, and the products being processed are placed in the transverse direction relative to the longitudinal axis of the product, as well as to the longitudinal axis of the processing lines with electric motors for processing products and mechanisms combined with them for performing auxiliary operations, and to the longitudinal axis of the bench; the products being processed are shifted from the processing lines using electric motors used for processing products and mechanisms for auxiliary operations, combined with the electric motors used for processing products, so that, when processing the products, all the auxiliary operations are performed simultaneously and automatically in each plane; the lengths of the products to be processed simultaneously shall be matched with respect to each other to meet the following condition: their total length shall be equal or as close as possible to the length of the standard input workpiece; the product processing is performed via moving the products being processed relative to the fixed electric motors used for processing products; the operations required for full processing of each product are divided into groups of operations—each group of operations processes simultaneously the products throughout the length of the same in one plane; here with the time of running all groups of operations shall be equal, or closely comparable to each other; each group of operations is performed in a separate operation performing zone; after completing a group of operations in the zone of performing these operations, the products are moved to the next operation zone for performing the following group of operations, and the zone of the previous operations shall be freed for performing this group of operations for processing the next product; starting from the number of a group of operations for processing the products in the first plane, corresponding to the quantity of groups of operations, into which the full cycle of products processing is divided, the processing of the products is performed simultaneously in all the processing planes; the procedure of simultaneous processing of product batches in all planes shall be repeated until the full completion of the product batch processing; the processing of the next product batch is performed in the same way.

To implement the proposed method of processing wood workpieces across the grain in three planes, a wood-processing bench is proposed, in which the workpiece moving is realized in the transverse direction relative to the longitudinal axis of the workpiece. The sequence of operations for full processing of a workpiece in three planes is divided into groups of operations to be performed either simultaneously or consecutively within a certain time period.

The indispensable condition of dividing a sequence of operations, as required for full processing of a workpiece in three planes, into groups of operations shall be the time of performing all the operations in one (any) group of operations which should be equal or comparable to the time of performing all operations in any other groups.

After completing a group of operations for workpiece processing, it is necessary to change the workpiece position in the space: the workpiece shall be moved from the zone of performing one group of operations into the zone of performing the following group of operations. Herewith the zone of performing the previous group of operations shall be freed from the workpiece and be ready for performing the group of operations for processing the next workpiece. Meeting all the above conditions provides for the following opportunities: during transverse moving of the workpiece, it is possible to process such workpiece across the grain simultaneously throughout all its length.

There is an opportunity to perform all the groups of operations simultaneously (performing of one group of operations does not hinder the simultaneous execution of other groups of operations).

Herewith, given equal time for performing each group of operations in respect with each other, the time of performing all the sequence of operations for full processing of one workpiece in three planes is reduced to the time of performing one group of operations.

The design performance rate of the benches based on this method of processing wood workpieces across the grain in three planes, as compared to existing analogs, is increased by an order of magnitude, i.e. 10 times.

This bench is optimized in terms of its performance parameters with four-sider straightening planers and is intended for use (it may be also used independently) within a process chain for industrial fabrication of building construction kits according to the Finnish method of double beams with insulation. The design of the bench, when processing the workpiece, provides for transverse moving of the workpiece in respect to the longitudinal axis of the same, i.e. it provides the opportunity of workpiece processing across the grain simultaneously throughout all its length. The sequence of operations for full processing of a workpiece in three planes is divided into groups, each group performing all the operations required for processing the workpiece in one plane.

When dividing the sequence of operations, as required for full processing of a workpiece in three planes, into groups of operations for processing of the workpiece in one plane, the following condition is met—the time of performing all the operations in one (any) group of operations is equal to the time of performing all the operations in any other group.

After completing a group of operations required for processing a workpiece in one plane, the workpiece position in space is changed: the workpiece is moved from the zone of performing one group of operation into the zone of performing the following group of operations.

Herewith the zone of performing the previous group of operations is freed from the workpiece and is ready for performing the group of operations for processing the following workpiece in the same plane.

As a result, the time of performing the full processing of one workpiece, with the opportunity of simultaneous processing of a workpiece throughout all its length, is reduced to the time of performing one group of operations.

The bench represents a wood-processing semi-automatic station serviced by two operators. The workpiece to be processed are planed beams or planks with a length of up to 6.1 meters. It is required to process the input workpiece in three planes. All processing operations being performed with the planks are located in one plane—on the plate face. The length of the finished products vary from 0.3 to 6.1 meters, as per specification. There is an opportunity of processing from one to three workpieces simultaneously. To optimize the process and increase the productivity, for the purpose of simultaneous processing based on the finished product specification, the lengths of the products shall be matched so as the sum of the lengths of the workpieces to be process shall be equal to the maximum length of 6.1 meter long workpieces or shall be as close as possible to this value.

Generally, an average building construction kit includes some series of workpieces of one size in an amount of 30 to 100 pcs.

For quick re-adjustment of the equipment for another series of workpieces, quick tool replacement etc., appropriate attachments with clamps, latches, etc. are provided.

The practice shows that building designs includes roughly the same number of long and short pieces, so the most rational shall be simultaneous processing of 2 products, the total length of which is close or equal to 6.1 meters.

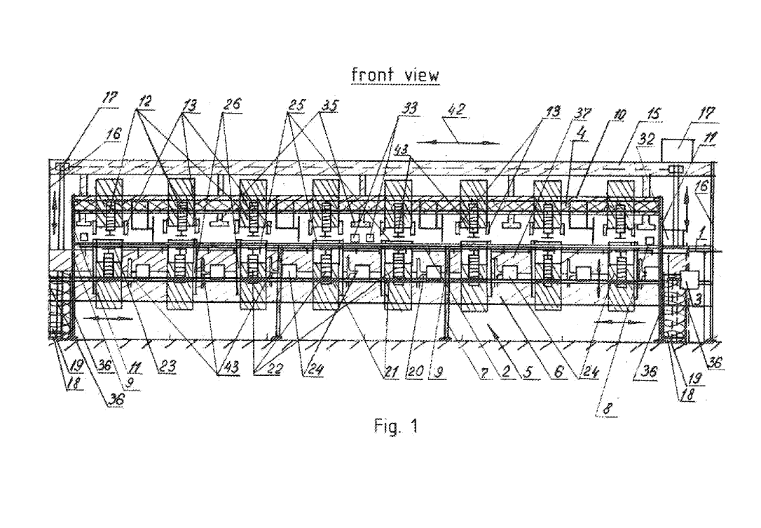

The essence of the claimed technical solutions is explained by the illustrations in FIGS. 1-5, wherein the bench design is schematically represented for implementation of the method and obtaining the finished product.

FIG. 1 is the front view;

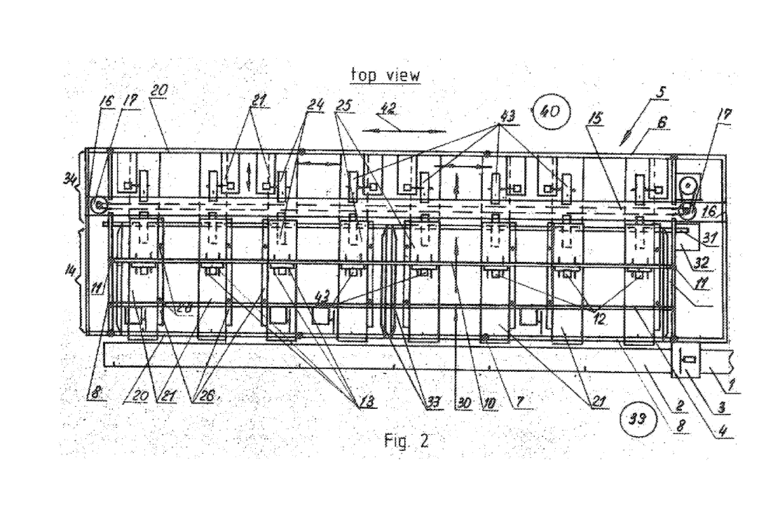

FIG. 2 is the top view;

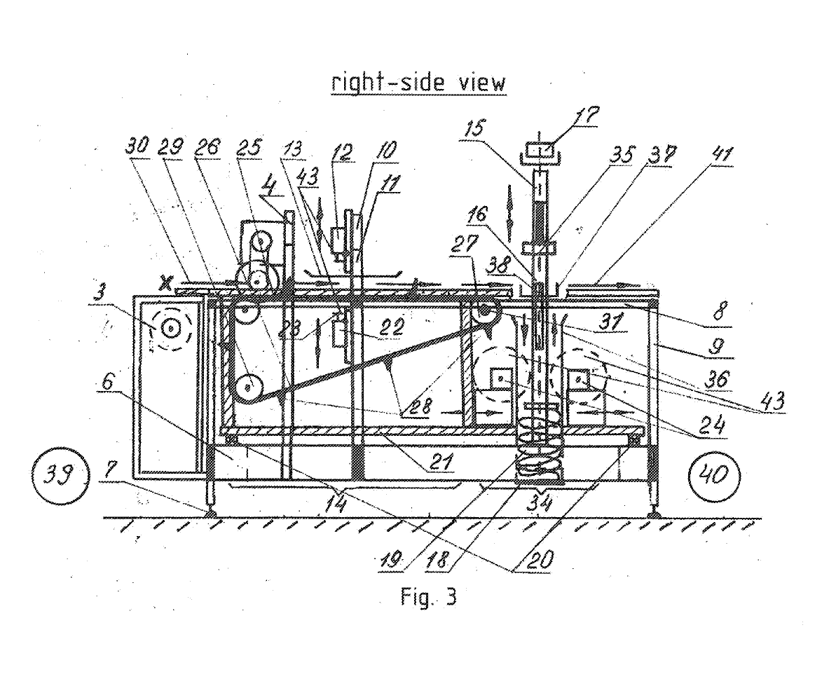

FIG. 3 is the right-side view, where:

1—input longitudinal roller table;

2—measuring table with swing-type stops for processing (trimming) the workpieces;

3—trimming mechanism;

4—zone of performing the first group of operations in the first plane (trimming);

5—general view of the frame;

6—main frame;

7—adjustable vertical support feet;

8—subframe;

9—subframe vertical poles;

10—second upper longitudinal boom;

11—vertical poles of the second upper longitudinal boom;

12—electric spindles (8 pcs);

13—mechanisms for automatic clamping of workpieces (8 pcs);

14—zone of workpieces processing in the second plane;

15—third upper longitudinal beam;

16—two vertical poles of the third upper longitudinal boom;

17—electric motor of “screw nut” type and clamping and feeding mechanism;

18—two supporting elements for attachment of springs (19) and a “screw nut” type drive (17) of the workpiece clamping and feeding mechanism;

19—springs;

20—rectangular linear guiding ways;

21—rectangular platforms installed perpendicular to the longitudinal axis of the bench;

22—spindles for processing the workpieces from below in the second plane (14);

23—processing the workpieces from below in the second plane (14);

24—spindles installed in pairs, for processing the workpieces from both sides in the third plane (34);

25—upper horizontal faces of the platforms (21);

26—chain transverse conveyors (8 pcs);

27—drive sprockets of the chain transverse conveyors;

28—stops of the chain transverse conveyors;

29—chain tensioners of the chain transverse conveyors;

30—direction of transverse moving of workpieces;

31—long driveshaft of the transverse conveyor drive;

32—electric motor of the driveshaft of the chain transverse conveyors (26);

33—quick-release guiding ways for positioning the workpieces lengthwise;

34—the area of processing the workpieces in the third plane;

35—stops for clamping and feeding the workpieces during processing in the third plane (34);

36—vertical guiding ways, between which a jig (37) with workpiece is moving;

37—jig for processing the workpieces in the third plane;

38—stops for positioning the workpieces lengthwise during processing in the third plane;

39—workplace of the first operator;

40—workplace of the second operator;

41—workpieces moving direction during processing in all planes;

42 platforms (21) moving direction for positioning relative to the frame;

43—cutting tools (cutters).

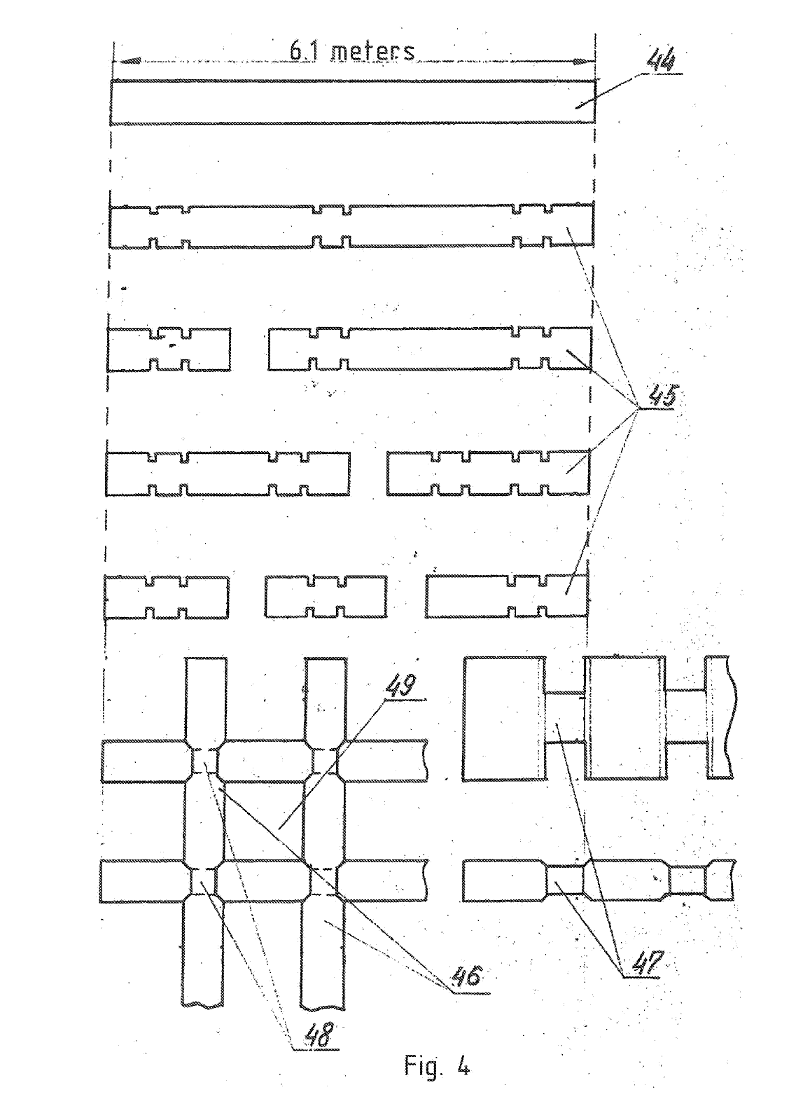

FIG. 4 scheme of the resulting product;

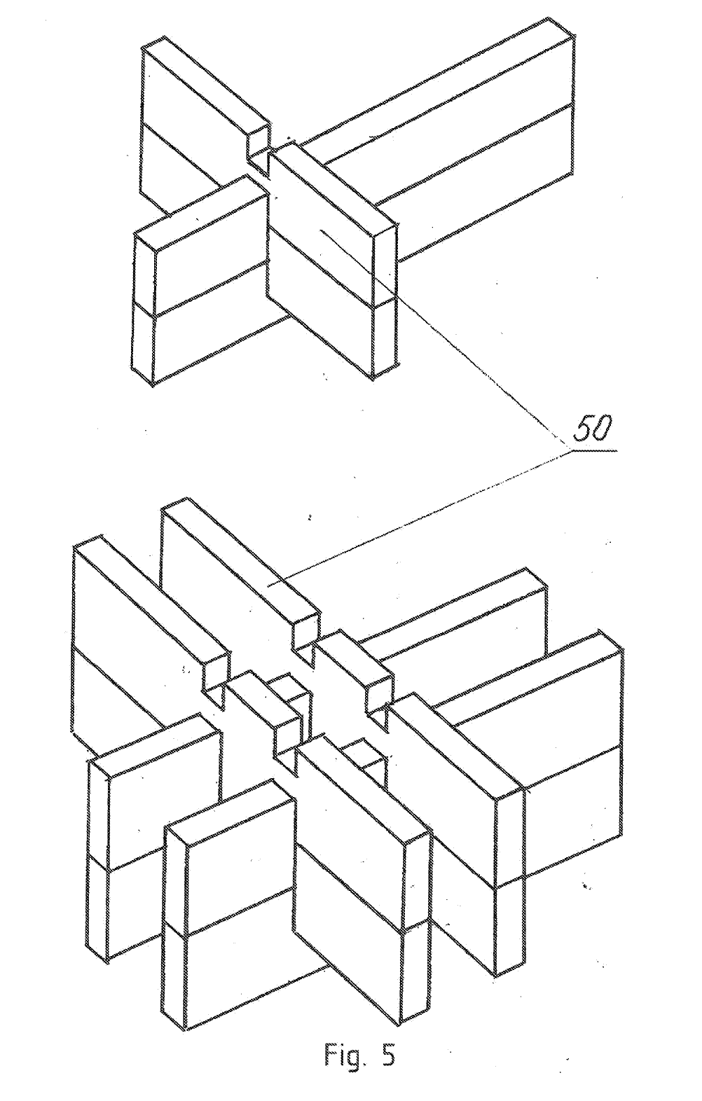

FIG. 5—options of angular connections of resulting products, where:

44—workpiece (up to 6.1 meter long);

45—types of standard products;

46—upper beams (planks);

47—cutting slots of “wind lock” type;

48—“wind lock” type connection;

49—angular connection as per the double-beam method;

50—options of angular connections as per single-beam and dual-beam methods.

### EXEMPLARY EMBODIMENT

The claimed method is implemented by using a bench, the design whereof includes a dual longitudinal roller table (1) to receive the input workpieces, a measuring table with swing-type stops (2) for lengthwise processing (trimming) the workpieces to the required size as per the product specification, a trimming mechanism (3) for processing workpieces in the first plane (the vertical plane, perpendicular to the longitudinal axis of workpieces). Positions 1, 2, 3 are the area of performing the first group of operations(4) in the first plane (trimming).

The welded metalframe is a long cuboid with three longitudinal booms in the upper part (5), which comprises a main frame (6) on adjustable vertical supporting feet (7); a subframe (8) on vertical supporting feet (9); a second upper longitudinal boom (10) on two vertical supporting feet (11) for attachment of eight spindles (12) and automatic clamping mechanisms (13) of workpieces to the zone of workpieces processing in the second plane (14); a third upper longitudinal boom(15) on two vertical supporting feet (16) for attachment of the “screw nut” type drive (17) of the clamping and feeding mechanism in the zone for processing workpiece sin the third plane (34); two supporting elements (18) for attachment of the “screw-nut” type drive (17) of the clamping and feeding mechanism and springs (19), ensuring the workpieces clamping in the conductor (37) during the operations of workpieces processing in the area of workpieces processing in the third plane (34). The trimming mechanism (3) is attached to the main frame (6) and the subframe (8). On the main frame (6), on two longitudinal linear guiding ways (20), eight platforms (21) are installed transversally with the option of free moving, quick positioning and fixing relative to the longitudinal axis of the bench, which is required for quick re-adjustment of the bench in case of transition from one type of processed products to another one. One spindle (22) is installed on each of the platforms (21) for processing workpieces from below (23) in the second plane (14) and two spindles (24),for processing workpieces from both sides in the third plane (34); each of eight platforms being equipped with upper horizontal faces (25) with chain transverse conveyors (26) with drive sprockets (27) with stops (28) with chain tensioners (29) for transversal moving (30) of the workpieces relative to the longitudinal axis of the bench for processing workpieces in the second plane (14). All stops (28) of all chain transverse conveyors (26) are located along straight lines according to the number of stops on each transverse conveyor with respect to each other, and these lines are strictly parallel to the longitudinal axis of the bench, as a consequence, during processing in the second plane the workpieces are moved perpendicularly to the longitudinal axis of the bench, but at the same time the longitudinal axes of the workpieces are parallel to the longitudinal axis of the bench, as a result of which the workpieces are processed in the direction which is strictly perpendicular to the longitudinal axis of the bench. Drive sprockets (27) are driven by the long driveshaft (31) of the transverse conveyor drive and can be moved along the driveshaft during the movement of the platforms (20) along the longitudinal axis of the bench. The electric motor (32) of the driveshaft (31) is attached to the subframe (8). The measuring table (2) is attached to the subframe (8); quick-release guiding ways (33) are attached to the subframe (8) and ensure positioning of the workpieces lengthwise in the zone of workpieces processing in the second plane (14). Eight spindles (12) are attached to the first upper longitudinal beam (10) for processing workpieces from above in the second plane and are equipped with mechanisms for automatic clamping (13) of the workpieces during the operation of the chain transverse conveyors (26). The equipment of the first upper longitudinal beam are eight processing units installed on two longitudinal linear guiding ways, with the option of moving, positioning and fixing relative to the longitudinal axis of the boom and the bench. At the top of the third upper longitudinal boom(14) is attached the “screw-nut” type drive (17) of the clamping and feeding mechanism with stops for clamping and feeding the workpieces (35) for processing the same in the third plane (34). Between the main frame (6) and the subframe (8),vertical guiding ways (36) are installed, between which, during the operation of the “screw-nut” type drive (17), a jig having a length of 6.1 meters (37), equipped with stops for positioning the workpieces (38),moves vertically downwards and ensures positioning of a workpiece in the zone of workpieces processing in the third plane (34). The “screw-nut” type drive (17) is a reversive one—upon completion of a working operation it returns to the initial position for performing the next working operation. Automatic clamping and positioning of the workpieces during the workpieces processing in the second plane is ensured by the transverse conveyor drive. All electric spindles of the tool drive have 2 fixed positions: “working position”-“idle position”, this function being necessary for quick re-adjustment of the equipment in case of changing in requirements for the finished product as per specification. On both sides, there are the workplace of the first operator (39) and the workplace of the second operator (40). The workpieces moving direction during the processing in all planes (41). The platforms (20) moving direction for positioning (42) relative to the frame (5). Cutting tools (saws, cutters) (43).

The embodiment is implemented as follows.

Based on a finished project for manufacturing a building construction kit, the first operator receives the tasks for manufacturing products as per specification including the sequence of the workpieces processing in order to ensure the maximum load of the bench throughout the possible length of a single workpieces processing. The first operator trims the workpieces lengthwise on the basis of the received specification and the sequence of workpieces processing. Using the measuring table, the first operator trim the first input workpiece to get the required sized of the finished products (the first group of operations is performed). The bench is adjusted for manufacturing a series of products with required dimensions: the operator adjusts and fixes the platforms (21) in the required positions, installs the necessary cutting tools (saws, cutters) (43) to the working positions, shifts the unused cutting tools (saws, cutters) to the idle position, installs the positioning guiding ways (33) on the subframe (8) for processing workpieces in the second plane, installs positioning stops (38) on the jig(37) for processing workpieces in the third plane. The operator checks the accuracy of the bench adjustment on the first workpiece processed at the ends to match the sizes of the required finished products. After full adjustment of the bench, he switches on the electric dives of the cutting tools (cutters) (43) and the electric motor of the chain transverse conveyors drive; the first operator feeds the first workpiece (several workpieces) to the transverse conveyors. During the processing of the second workpiece by the first operator in the first plane (4), the first workpiece, by means of stops (28) installed on the chain transverse conveyors (26), moves in the direction perpendicular to the longitudinal axis of the bench (30), is automatically positioned in the horizontal plane by means of the guiding ways (33), is automatically positioned in the vertical plane by means of the mechanical clamps (13) immediately at the time of processing in the second plane, is processed from above and from below in the second plane (14), is automatically released from the clamps, (the second group of operations is performed), and then the workpiece leaves the processing zone and is moved to the zone of the third group of operations. During the processing by the first operator of the third workpiece in the first plane, the second workpieceis simultaneously, automatically, by means of the electric drive (32) of the chain transverse conveyors, subjected to the full operation of processing in the second plane (14). Simultaneously, the second operator installs the first workpiece in the jig (37), where the workpiece is automatically positioned lengthwise by means of stops (38), and then the second operator switches on the“screw nut” type electric motor (17) for lowering, the clamps installed on the top of this drive grip the workpiece, overcoming the action of the springs that hold the jig in the upper position. The “screw-nut” drive (17) keeps moving the jig (37)downwards with the workpiece installed thereon, when the jig (37) with the workpiece is moving downward, the operating cutting tool (43) performs the workpiece processing in the third plane (34), whereupon the “screw-nut” mechanism (17) returns the jig (37) to the initial position. The second operator frees the jig (37) from the finished product, i.e. the third group of operations if performed in the third plane (34), and the second operator proceeds to processing the next workpiece. Subsequently, all three groups of operations in all three planes are repeated and performed simultaneously.

Processing of each next series of workpieces is performed in the similar way.

When building houses using the double-beam method, as compared to the single-beam building method, the number of slots per angular connection increases fourfold, as a consequence, the performance rate of existing equipment additionally decreases four times.

The advantages of the proposed method of workpieces processing are as follows:
the ability to perform simultaneously all the working operations throughout the workpiece length in any plane;
the ability to perform simultaneously all the working operations throughout the workpiece length in three planes;
dividing all the operations, as required for workpiece processing, into groups of operations, provided that the time periods of performing a group of operations is equal between them;
groups of operations may be performed in any sequence with respect to each other;

the zone of workpiece processing is freed from the workpiece when performing groups of operations, providing the opportunity of simultaneous performing the next workpiece processing;
one-time workpiece positioning, fixing, etc. when performing each (any) group of operations throughout the length of the workpiece;
significant unproductive waste of time is reduced to the maximum extent, as a consequence, performance of the Equipment sharply increases, on the basis of the proposed method of workpieces processing;
the time of execution of all operations for processing workpieces in case of workpieces series processing, is virtually reduced to the time of performing one group of operations.

The greatest effect of increased productivity is obvious in construction of buildings by the double-beam method, given that the number of slots per angular connection using this method is increased fourfold as compared to the single-beam construction method.

Despite the good qualities of buildings constructed by the double-beam method, surpassing in term of quality the buildings constructed using the single-beam method and other existing technologies, the double-beam method did not became widespread because of complexity of implementation of a high-performance industrial production of building construction kits using this method. The claimed invention solves this problem, as a consequence, the use of the bench enables the consumer to purchase a sustainable house, with better energy-saving parameters as compared to houses from single beams, while reducing about two times the construction costs due to twofold reducing in the wood consumption as compared to single-beam houses.

1. Method of processing wood products across the grain n two or more planes with various cross-section shapes, including orientation, locating, with subsequent clamping, feeding and processing along the mutually perpendicular generatrices, characterized in that multiple products can be processed at the same time, here with the products being processed are placed in the transverse direction relative to the longitudinal axis of the product, as well as to the longitudinal axis of the processing lines with electric motors for processing products and mechanisms combined with them for performing auxiliary operations, and to the longitudinal axis of the bench; the products being processed are shifted from the processing lines with electric motors used for processing products and mechanisms for auxiliary operations, combined with electric motors used for processing products, so that, when processing workpieces, all the auxiliary operations are performed simultaneously and automatically in each plane; the lengths of the products to be processed simultaneously shall be matched with respect to each other to meet the following condition—their total length shall be equal or as close as possible to the length of the standard input workpiece; the product processing is performed by means of moving the workpieces being processed relative to the fixed electric drives for processing products; the operations required to perform the full processing of each product, are divided into groups of operations—each group of operations processes simultaneously the products throughout the length of the products in one plane; here with the time of running all the groups of operations shall be equal, or closely comparable to each other; each group of operations is performed in a separate operation performing zone; after completing a group of operations in the zone of performing these operations, the products are moved to the next operation zone to perform the next groups of operations, and the zone of the previous operations shall be freed to perform these groups of operations for processing the next workpiece; starting from the number of a group of operations for processing the products in the first plane, corresponding to the quantity of groups of operations, into which the full cycle of products processing is divided, the processing of the products is performed simultaneously in all the processing planes; the procedure of simultaneous processing of product batches in all planes shall be repeated until the full completion of the product batch processing: the processing of the next product batch is performed in the same way.
